(19) United States
(12) Patent Application Publication
(10) Pub. No.: US 2025/0012624 A1
(43) Pub. Date: Jan. 9, 2025

(54) Method and System for Blade Tip Timing Measurement of Full-frequency-domain Vibration of Rotor Blade

(71) Applicant: XI'AN JIAOTONG UNIVERSITY, Xi'an (CN)

(72) Inventors: Baijie QIAO, Xi'an (CN); Yuda Zhu, Xi'an (CN); Yanan Wang, Xi'an (CN); Zhibo Yang, Xi'an (CN); Hongrui Cao, Xi'an (CN); Xuefeng Chen, Xi'an (CN)

(21) Appl. No.: 18/590,618

(22) Filed: Feb. 28, 2024

(30) Foreign Application Priority Data
Jun. 30, 2023 (CN) 2023

(51) Int. Cl. G01H 17/00; F01D 21/00

(52) U.S. Cl. CPC G01H 17/00; F01D 21/003; F05D 2270/334

(57) ABSTRACT

Disclosed are a method and system for blade tip timing measurement of full-frequency-domain vibration of a rotor blade. The method includes: identifying low-frequency, medium-frequency, high-frequency, and super-high-frequency mode parameters of the rotor blade to determine the number and mounting angles of sensors; identifying low-frequency vibration parameters based on blade tip timing according to blade tip vibration displacement; identifying medium-frequency vibration parameters based on blade tip timing according to blade tip vibration velocity; and identifying high-frequency vibration parameters based on blade tip timing according to blade tip acceleration and identifying super-high-frequency vibration parameters based on blade tip timing according to blade tip jerk. The present disclosure also provides a system for implementing the method for full-frequency-domain vibration measurement based on blade tip timing. The method for blade tip timing measurement of full-frequency-domain vibration extends the range of blade vibration frequency effectively measured by the blade tip timing technology.

### CROSS-REFERENCE TO RELATED APPLICATION

This application claims priorities from the Chinese patent application 2023107968510 filed Jun. 30, 2023, the content of which is incorporated herein in the entirety by reference.

### TECHNICAL FIELD

The present disclosure relates to the technical field of non-contact measurement of rotor blades of rotary machinery, in particular to a method and system for blade tip timing measurement of full-frequency-domain vibration of a rotor blade.

### BACKGROUND

Blade tip timing (BTT) is a non-contact measurement technique that is widely applied to the measurement and monitoring of blade vibration of turbomachinery. This technique can obtain the circumferential vibration displacement of all the blades of the same stage by mounting timing sensors on the circumference of a casing, and comparing the measured actual time of arrival of the blades with the theoretical or ideal time of arrival of the blades without vibration, in combination with the rotor speed. However, the conventional displacement-based blade tip timing measurement method can obtain the low-frequency blade bending vibration parameter but still has difficulty in accurately measuring the medium-frequency, high-frequency, and super-high-frequency blade vibration. Generally, the dynamic frequency of fan blades is low. However, for compressors, especially high-pressure compressors, the first-order frequency is several thousand hertz. Therefore, it is particularly important to measure and monitor the medium-frequency, high-frequency, and super-high-frequency blade vibration. The blade vibration can be defined as different physical quantities such as displacement, velocity acceleration, or jerk, possessing characteristics of unchanged periodicity and frequency. The vibration signals of different frequency components can be enhanced according to the signal characteristics of different physical quantities. Accordingly, the present disclosure provides a method and system for realizing full-frequency-domain vibration measurement based on blade tip timing by obtaining blade vibration responses of different measured physical quantities. It is possible to provide more comprehensive blade vibration information and provide a more reliable basis for blade vibration analysis and fault diagnosis. This method is a further development and improvement of blade tip timing technology and has important application value in the operation, maintenance, and fault early warning for turbomachinery.

The above information disclosed in the background section is only for the enhancement of understanding of the background of the present disclosure and therefore may contain information that does not constitute the prior art that is well known to a person having ordinary skill in the art.

### SUMMARY

Aiming at the shortcomings in the prior art, the purpose of the present disclosure is to provide a method and system for full-frequency-domain vibration measurement based on blade tip timing, which solves the drawbacks that it is difficult for the conventional displacement-based blade tip timing measurement method to accurately measure the medium-frequency, high-frequency and super-high-frequency blade vibration and implements full-frequency-domain vibration measurement based on blade tip timing using blade tip vibration displacement, blade tip vibration velocity, blade tip vibration acceleration and blade tip vibration jerk, respectively.

In order to achieve the above object, the present disclosure provides technical solutions as follows:

A method for blade tip timing measurement of full-frequency-domain vibration of a rotor blade of the present disclosure includes:
first step S1, performing prestress modal analysis on the rotor blade to obtain a low-frequency mode parameter with a vibration frequency being less than 500 Hz, a medium-frequency mode parameter with a vibration frequency in the range of 500 Hz-2000 Hz, a high-frequency mode parameter with a vibration frequency in the range of 2000 Hz-5000 Hz and a super-high frequency mode parameter with a vibration frequency being greater than 5000 Hz, to determine the number and mounting angles of blade tip timing sensors;
second step S2, mounting the blade tip timing sensors on an engine casing circumferentially to obtain a time sequence of the rotor blade arriving at the blade tip timing sensors, and determining a reference rotational speed based on the time sequence;
third step S3, obtaining an ideal time of arrival \hat{t}_{i,b,n} of the blade according to the reference rotational speed and the mounting angles of the sensors based on the low-frequency vibration parameter with the vibration frequency being less than 500 Hz, obtaining a time difference Δ\hat{t}_{i,b,n} in combination with the measured actual time t_{i,b,n} of the rotor blade arriving at the blade tip timing sensors, wherein Δt_{i,b,n}=\hat{t}_{i,b,n}−t_{i,b,n}, obtaining a blade tip vibration displacement based on a measured rotation radius R_{BTT} from a rotor-tip rotation axis to a blade tip and the time difference Δt_{i,b,n}, obtaining a blade tip vibration velocity according to a relationship between the measured actual time of arrival of the blade and the mounting angles of adjacent sensors based on the medium-frequency vibration parameter with the vibration frequency in the range of 500 Hz-2000 Hz, obtaining a blade tip vibration acceleration according to the mounting angles of three adjacent blade tip timing sensors and the measured actual time of arrival of the blade based on the high-frequency vibration parameter with the vibration frequency in the range of 2000 Hz-5000 Hz, and obtaining a blade tip vibration jerk according to the mounting angles of four adjacent blade tip timing sensors and the measured actual time of arrival of the blade based on the super-high-frequency vibration parameter with the vibration frequency being greater than 5000 Hz, wherein the vibration parameters include a frequency, an amplitude and a phase; and
fourth step S4, obtaining a vibration frequency, amplitude, and phase of the rotor blade at low frequency, medium frequency, high frequency, and super-high frequency using the obtained blade tip vibration displacement, blade tip vibration velocity, blade tip vibration acceleration, and blade tip vibration jerk.

In the first step S1 of the method, prestress modal analysis is performed on the rotor blade to obtain a low-frequency mode f_{L} with a vibration frequency being less than 500 Hz, a medium-frequency mode f_{M} with a vibration frequency in the range of 500 Hz-2000 Hz, a high-frequency mode f_{H} with the vibration frequency in the range of 2000 Hz-5000 Hz and a super-high-frequency mode f_{S} with the vibration frequency being greater than 5000 Hz of the rotor blade at a given operating condition; the number Nₚ of the blade tip timing sensors is determined based on the number m of frequency components of the low-frequency mode f_{L}, the medium-frequency mode f_{M}, the high-frequency mode f_{H}, and the super-high-frequency mode f_{S}, wherein Nₚ≥2m+1.

In the first step S1 of the method, a blade tip timing sensor circumferential mounting angle measurement matrix Θ is constructed according to the frequency components of the low-frequency mode f_{L}, the medium-frequency mode f_{M}, the high-frequency mode f_{H} and the super-high-frequency mode f_{S}, wherein an expression of the angle measurement matrix Θ is:

$$Θ = [ \begin{matrix}sin ( 2 π {f}_{L} {θ}_{1} ) & cos ( 2 π {f}_{L} {θ}_{1} ) & sin ( 2 π {f}_{M} {θ}_{1} ) & cos ( 2 π {f}_{M} {θ}_{1} ) & sin ( 2 π {f}_{H} {θ}_{1} ) & cos ( 2 π {f}_{H} {θ}_{1} ) & sin ( 2 π {f}_{S} {θ}_{1} ) & sin ( 2 π {f}_{S} {θ}_{1} ) \\ sin ( 2 π {f}_{L} {θ}_{2} ) & cos ( 2 π {f}_{L} {θ}_{2} ) & sin ( 2 π {f}_{M} {θ}_{2} ) & cos ( 2 π {f}_{M} {θ}_{2} ) & sin ( 2 π {f}_{H} {θ}_{2} ) & cos ( 2 π {f}_{H} {θ}_{2} ) & sin ( 2 π {f}_{S} {θ}_{2} ) & cos ( 2 π {f}_{S} {θ}_{2} ) \\ ⋮ & ⋮ & ⋮ & ⋮ & ⋮ & ⋮ & ⋮ & ⋮ \\ sin ( 2 π {f}_{L} {θ}_{{N}_{p}} ) & cos ( 2 π {f}_{L} {θ}_{{N}_{p}} ) & sin ( 2 π {f}_{M} {θ}_{{N}_{p}} ) & cos ( 2 π {f}_{M} {θ}_{{N}_{p}} ) & sin ( 2 π {f}_{H} {θ}_{{N}_{p}} ) & cos ( 2 π {f}_{H} {θ}_{{N}_{p}} ) & sin ( 2 π {f}_{S} {θ}_{{N}_{p}} ) & cos ( 2 π {f}_{S} {θ}_{{N}_{p}} )\end{matrix} ]$$

where θ_{N}_{ₚ} is the mounting angle between the Nₚ^{th} blade tip timing sensor and the rotational speed sensor; a circumferential layout cond(Θ)=∥Θ∥□∥Θ⁻¹∥ of the blade tip timing sensors is determined according to a condition number of the angle measurement matrix.

In the second step S2 of the method, an OPR rotational speed sensor is mounted to measure the time sequence τ_{OPR,n}, and a reference rotational speed fᵣ within the n^{th} revolution is calculated according to the time sequence τ_{OPR,n}, wherein

$${f}_{r} = \frac{1}{{τ}_{OPR , n + 1} - {τ}_{OPR , n}} .$$

In the second step S2 of the method, the reference rotational speed fᵣ within the n^{th} revolution is calculated according to the actual time of arrival t_{i,b,n} of the N_{b}^{th} blade measured by the Nₚ^{th} blade tip timing sensor:

$${f}_{r} = \frac{1}{{N}_{b} {N}_{p}} {\sum }_{b = 1}^{{N}_{b}} {\sum }_{i}^{{N}_{p}} ( {t}_{i , b , n + 1} - {t}_{i , b , n} ) \{ \begin{matrix}i = 1 , 2 , … {N}_{p} \\ b = 1 , 2 , … {N}_{b} \\ n = 1 , 2 , … , N\end{matrix} .$$

In the method, the third step S3 includes:
S301, obtaining a vibration displacement d_{i,b,n} of the b^{th} blade tip within the n^{th} revolution measured by the i^{th} blade tip timing sensor according to the measured rotation radius R_{BTT} from the rotor-tip rotation axis to the blade tip based on the low-frequency vibration parameter with the vibration frequency being less than 500 Hz, wherein, d_{i,b,n}=2πR_{BTT}Δt_{i,b,n}, wherein the time difference Δt_{i,b,n}=\hat{t}_{i,b,n}−Δt_{i,b,n};
S302, calculating a vibration velocity ν_{b,n}^{i,j} of the b^{th} blade tip within the n^{th} revolution using two adjacent blade tip timing sensors, i.e., the i^{th} blade tip timing sensor and the j=i+1^{th} blade tip timing sensor, and the measured actual time of arrival based on the medium-frequency vibration parameter with the vibration frequency in the range of 500 Hz-2000 Hz, wherein

$${v}_{b , n}^{i , j} = {R}_{BTT} ( \frac{{θ}_{j} - {θ}_{i}}{{t}_{j , b , n} - {t}_{i , b , n}} - 2 π {f}_{r} ) ,$$

θᵢ and θᵢ are the mounting angles between the i^{th} blade tip timing sensor and the j^{th} blade tip timing sensor and the rotational speed sensor, respectively, the actual time of the blade arriving at the i^{th} blade tip timing sensor is t_{i,b,n}, and the actual time of the blade arriving at the j^{th} blade tip timing sensor is t_{j,b,n};
S303, calculating a vibration acceleration a_{b,n}^{i,j,l} of the b^{th} blade tip within the n^{th} revolution using three adjacent blade tip timing sensors, i.e., the i^{th} blade tip timing sensor, the j=i+1^{th} blade tip timing sensor, and the l=i+2^{th} blade tip timing sensor, and the measured actual time of arrival based on the high-frequency vibration parameter with the vibration frequency in the range of 2000 Hz-5000 Hz, wherein

$${a}_{b , n}^{i , j , l} = \frac{2 {R}_{B T T} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ,$$

where β represents the angular acceleration of the rotor; when the rotor speed is constant, the angular acceleration of the rotor is β=0, at this time, the blade tip vibration acceleration is expressed as:

$${a}_{b , n}^{i , j , l} = \frac{2 {R}_{B T T} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} ;$$

when the rotor speed is variable, the angular acceleration of the rotor is β≠0, at this time, the blade tip vibration acceleration is expressed as:

$${a}_{b , n}^{i , j , l} = 2 {R}_{B T T} \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β$$

S304, calculating a vibration jerk γ_{b,n}^{i,j,l,q} of the b^{th} blade tip within the n^{th} revolution using four adjacent blade tip timing sensors, i.e., the i^{th} blade tip timing sensor, the j=i+l^{th} blade tip timing sensor, the l=i+2^{th} blade tip timing sensor, and the q=i+3^{th} blade tip timing sensor, and the measured actual time-of-arrival sequence based on the super-high-frequency vibration parameter with the vibration frequency being greater than 5000 Hz, wherein,

$${γ}_{b , n}^{i , j , l , q} = 2 {R}_{BTT} \frac{\frac{( \frac{{θ}_{q} - {θ}_{l}}{{t}_{q , b , n} - {t}_{l , b , n}} - \frac{{θ}_{l} - {θ}_{j}}{{t}_{l , b , n} - {t}_{jb , n}} )}{{t}_{q , b , n} - {t}_{j , b , n}} - \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}}}{\frac{{t}_{q , b , n} + 2 {t}_{l , b , n} + {t}_{j , b , n}}{4} - \frac{{t}_{l , b , n} + 2 {t}_{j , b , n} + {t}_{i , b , n}}{4}} .$$

In the fourth step S4 of the method, a blade tip vibration measurement response Y is generated based on the blade tip vibration displacement, the blade tip vibration velocity, the blade tip vibration acceleration and the blade tip vibration jerk, and the blade tip timing vibration parameters

$$Φ = = {( {\sum }_{i = 1}^{M} {Θ}^{T} Θ )}^{- 1} ( {\sum }_{i = 1}^{M} {Θ}^{T} Y )$$

at different frequency bands are solved by a least squares method.

In the method, the blade tip timing vibration parameter is solved based on the vibration displacement to obtain low-frequency vibration amplitude Am_{f}_{_{L}} and phase Ψ_{f}_{_{L}} of the blade, the blade tip timing vibration parameter is solved based on the vibration velocity to obtain medium-frequency vibration amplitude Am_{f}_{_{M}} and phase Ψ_{f}_{_{M}} of the blade, wherein

$${Am}_{{f}_{M}} = 2 π {f}_{L} A {m}_{{f}_{L}} , \qquad {Ψ}_{{f}_{M}} = {Ψ}_{{f}_{L}} - \frac{π}{2} ;$$

the blade tip timing vibration parameter is solved based on the vibration acceleration to obtain high-frequency vibration amplitude Am_{f}_{_{H}} and phase Ψ_{f}_{_{H}} of the blade, wherein Am_{f}_{_{H}}=(2πf_{L})²Am_{f}_{_{L}}, Ψ_{f}_{_{H}}=Ψ_{f}_{_{L}}−π; the blade tip timing vibration parameter is solved based on the vibration jerk to obtain super-high-frequency vibration amplitude Am_{f}_{_{S}} and phase Ψ_{f}_{_{S}} of the blade, wherein

$$A {m}_{{f}_{S}} = {( 2 π {f}_{L} )}^{3} A {m}_{{f}_{L}} , \qquad {Ψ}_{{f}_{S}} = {Ψ}_{{f}_{L}} - \frac{3 π}{2} .$$

A system for implementing the method for blade tip timing measurement of full-frequency-domain vibration of a rotor blade includes:
a sensor layout optimization module, configured to determine the number and circumferential mounting angle of blade tip timing sensors for measuring vibration of the rotor blade based on low-frequency, medium-frequency, high-frequency, and super-high-frequency vibration parameters of the rotor blade;
a time-of-arrival online measurement module, configured to acquire a time sequence of the rotor blade arriving at the blade tip timing sensors;
a blade tip vibration calculation module, connected with the time-of-arrival online measurement module and the sensor layout optimization module, and configured to calculate a blade tip vibration displacement identified at a low frequency, a blade tip vibration velocity identified at a medium frequency, an acceleration for identified at a high frequency, and a jerk identified at a super-high frequency using the measured time sequence; and
a vibration parameter identification module, connected with the blade tip vibration calculation module, and configured to obtain the frequency, amplitude, and phase of the rotor blade at the low frequency, the medium frequency, the high frequency, and the super-high frequency by a least squares algorithm based on the blade tip vibration displacement, the blade tip vibration velocity, the blade tip vibration acceleration, and the blade tip vibration jerk.

In the system, an interval between two adjacent blade tip timing sensors is within 10°.

### Beneficial Effects

The method provided by the present disclosure calculates the blade tip vibration displacement, the blade tip vibration velocity, the blade tip vibration acceleration and the blade tip vibration jerk using the optimized sensor angles and measured time sequence of the blade arriving at the sensors, thereby obtaining different frequency-enhanced components of blade vibration at low frequency, medium frequency, high frequency and super-high frequency, and the vibration parameters of the blade at different frequency bands are obtained by using the least square algorithm; compare with that traditional method for identifying the vibration parameters of the blade at low frequency from vibration displacement based on blade tip timing, the disclosure can realize the full-frequency-domain test of blade tip timing from low-frequency, medium-frequency, high-frequency and super-high-frequency; the method for measuring the displacement, velocity, acceleration and jerk based on blade tip timing can still realize the measurement of full-frequency-domain vibration parameters under the conditions of no rotational speed and variable rotational speed, and further expands the engineering application of the blade tip timing technology.

### BRIEF DESCRIPTION OF FIGURES

In order to illustrate the technical solutions in embodiments of the present application or the prior art more clearly, the drawings required to be used in the embodiments will be described briefly below. Obviously, the drawings in the following description are merely illustrative of some embodiments of the present disclosure. Other drawings may be obtained by a person having ordinary skill in the art from these drawings.

Various additional advantages and benefits of the present disclosure will become apparent to a person having ordinary skill in the art upon reading the following detailed description of the preferred embodiments. The drawings are only to illustrate preferred embodiments and are not considered to be limitations to the present disclosure. It is obvious that the drawings described below are merely some embodiments of the present disclosure, and a person having ordinary skill in the art can also obtain other drawings according to these drawings without creative efforts. Also, like reference numerals refer to like parts throughout the drawings.

In the drawings:

FIG. 1 is a flowchart of a method for full-frequency-domain vibration measurement based on blade tip timing according to an embodiment of the present disclosure;

FIG. 2 is a structural schematic diagram of a system for implementing the method for full-frequency-domain vibration measurement based on blade tip timing according to an embodiment of the present disclosure; and

FIG. 3 is a schematic diagram of a blade tip timing measurement system and a blade tip timing sensor layout according to an embodiment of the present disclosure.

The present disclosure will be further explained below with reference to the drawings and embodiments.

### DETAILED DESCRIPTION

In order to make the objects, technical solutions, and advantages of the embodiments of the present disclosure clear, the technical solutions in the embodiments of the present disclosure will be clearly and completely described below in conjunction with the embodiments of the present disclosure, and it is obvious that the embodiments described are some, but not all, embodiments of the present disclosure. Based on the embodiments of the present disclosure, other embodiments obtained by a person having ordinary skill in the art without creative work all belong to the scope of protection of the present disclosure.

Thus, the following detailed description of the embodiments of the disclosure, as provided in the figures, is not intended to limit the scope of the disclosure, as claimed, but is merely representative of selected embodiments of the disclosure. Based on the embodiments of the present disclosure, other embodiments obtained by a person having ordinary skill in the art without creative work all belong to the scope of protection of the present disclosure.

It should be noted that like reference numerals and letters represent like items in the following figures, and therefore, once an item is defined in one figure, it does not need to be further defined and explained in the subsequent figures.

In the description of the disclosure, it needs to be understood that, the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like indicate an orientation or positional relationship based on the orientation or positional relationship shown in the drawings, only for ease of description of the disclosure and for simplicity of description, it is not intended to indicate or imply that the device or element referred to must have a particular orientation, be constructed and operate in a particular orientation, and therefore should not be construed as limiting the disclosure.

Furthermore, the terms “first” and “second” are used for descriptive purposes only, and cannot be understood to indicate or imply relative importance or to implicitly specify the number of technical features indicated. Thus, features defined by “first” and “second” may explicitly or implicitly include one or more of that feature. In the description of the present disclosure, “plurality of” means two or more, unless expressly and specifically defined otherwise.

As used herein, unless expressly specified and limited otherwise, the terms “mounted”, “connected”, “connection”, “secured” and the like are to be construed broadly, e.g., the connection may be fixed connection or detachable connection, or integrated connection; the connection may be a direct connection or indirect connection through an intermediate medium and may be in communication between two elements or in an interacting relationship between two elements. The specific meaning of the above terms in the present disclosure can be understood by a person having ordinary skill in the art according to specific circumstances.

In the present disclosure, unless expressly specified and defined otherwise, a first feature being “above” or “below” a second feature may include that the first and second features are in direct contact or that the first and second features are not in direct contact but are in contact through another feature between them. Also, a first feature being “on”, “above” and “over” a second feature includes that the first feature is located directly above and obliquely above the second feature, or simply indicates that the first feature is at a higher level than the second feature. A first feature being “under”, “below” and “beneath” a second feature includes that the first feature is located directly below and obliquely below the second feature, or simply indicates that the first feature is at a lower level than the second feature.

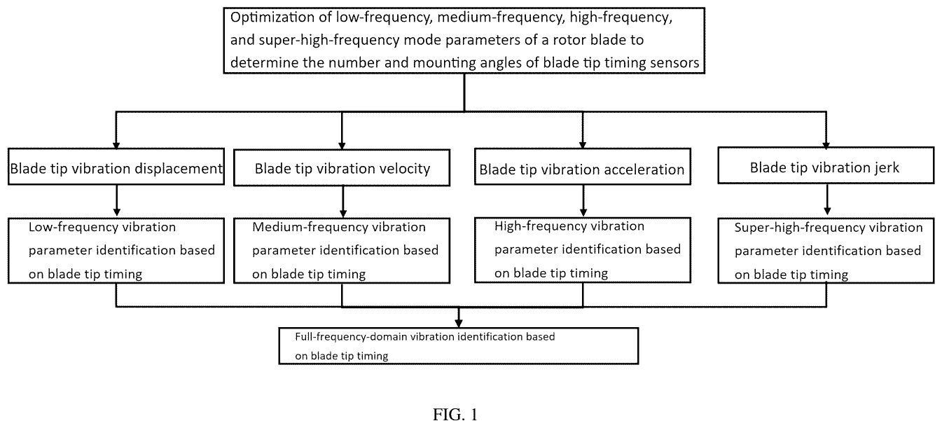

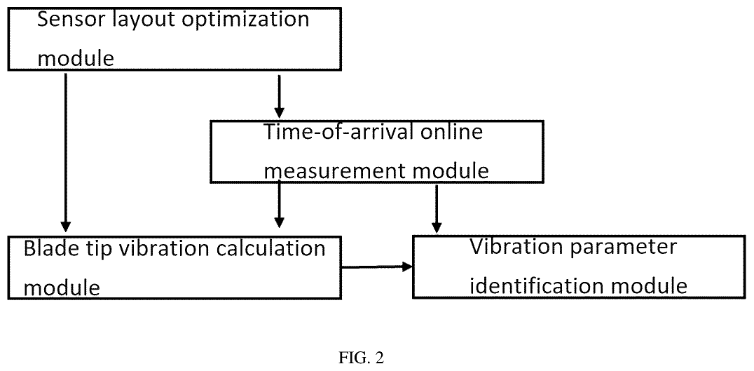

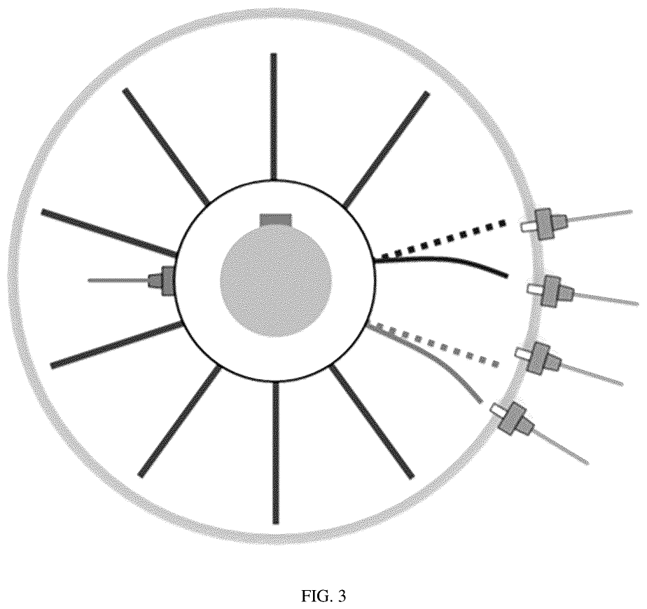

In order to make those skilled in the art better understand the technical solution of the present disclosure, the present disclosure will be further described in detail with reference to FIGS. 1 to 3. A method for blade tip timing measurement of full-frequency-domain vibration of a rotor blade includes:
first step S1, performing prestress modal analysis on the rotor blade to obtain low-frequency, medium-frequency, high-frequency, and super-high-frequency mode parameters, and determining the number and mounting angles of blade tip timing sensors based on identified mode parameters;
second step S2, circumferentially mounting the blade tip timing sensors on an engine casing for performing a test and acquiring a time sequence of the rotor blade arriving at the sensor, and determining a reference rotational speed based on the time sequence;
third step S3, converting the measured physical quantities into blade tip vibration displacement, blade tip vibration velocity, blade tip vibration acceleration, and blade tip vibration jerk, respectively using the time of arrival and the mounting angles of the sensors according to different identification requirements of low-frequency, medium-frequency, high-frequency and super-high-frequency vibration parameters;
fourth step S4, performing vibration parameter identification based on blade tip timing using the obtained different blade tip vibration physical quantities to obtain information such as vibration frequency, vibration amplitude, and vibration phase of the rotor blade at low frequency, medium frequency, high frequency, and super-high frequency.

In the first step S1 of the method, prestress modal analysis is performed on the rotor blade to obtain a low-frequency mode (f_{L}) with a vibration frequency being less than 500 Hz, a medium-frequency mode (f_{M}) with a vibration frequency in the range of 500 Hz to 2000 Hz, a high-frequency mode (f_{H}) with the vibration frequency in the range of 2000 Hz to 5000 Hz, and a super-high-frequency mode (f_{S}) with the vibration frequency being greater than 5000 Hz of the rotor blade at a given operating condition; the number Nₚ of the blade tip timing sensors is determined according to the number m of frequency components of the rotor blade at the low frequency, the medium frequency, the high frequency and the super-high frequency, wherein

$${N}_{p} \geq 2 m + 1 ;$$

in the first step S1 of the method, a blade tip timing circumferential mounting angle measurement matrix Θ is constructed based on the frequency components of the rotor blade at the low frequency (f_{L}), the high frequency (f_{M}), the high frequency (f_{H}) and the super-high frequency (f_{S}), wherein an expression of the sensor measurement matrix Θ is:

$$Θ = [ \begin{matrix}sin ( 2 π {f}_{L} {θ}_{1} ) & cos ( 2 π {f}_{L} {θ}_{1} ) & sin ( 2 π {f}_{M} {θ}_{1} ) & cos ( 2 π {f}_{M} {θ}_{1} ) & sin ( 2 π {f}_{H} {θ}_{1} ) & cos ( 2 π {f}_{H} {θ}_{1} ) & sin ( 2 π {f}_{S} {θ}_{1} ) & sin ( 2 π {f}_{S} {θ}_{1} ) \\ sin ( 2 {πf}_{L} {θ}_{2} ) & cos ( 2 π {f}_{L} {θ}_{2} ) & sin ( 2 π {f}_{M} {θ}_{2} ) & cos ( 2 π {f}_{M} {θ}_{2} ) & sin ( 2 π {f}_{H} {θ}_{2} ) & cos ( 2 π {f}_{H} {θ}_{2} ) & sin ( 2 π {f}_{S} {θ}_{2} ) & cos ( 2 π {f}_{S} {θ}_{2} ) \\ ⋮ & ⋮ & ⋮ & ⋮ & ⋮ & ⋮ & ⋮ & ⋮ \\ sin ( 2 π {f}_{L} {θ}_{{N}_{p}} ) & cos ( 2 π {f}_{L} {θ}_{{N}_{p}} ) & sin ( 2 π {f}_{M} {θ}_{{N}_{p}} ) & cos ( 2 π {f}_{M} {θ}_{{N}_{p}} ) & sin ( 2 π {f}_{H} {θ}_{{N}_{p}} ) & cos ( 2 π {f}_{H} {θ}_{{N}_{p}} ) & sin ( 2 π {f}_{S} {θ}_{{N}_{p}} ) & cos ( 2 π {f}_{S} {θ}_{{N}_{p}} )\end{matrix} ]$$

where θ_{N}_{ₚ} is the mounting angle between the Nₚ^{th} blade tip timing sensor and a rotational speed sensor; a circumferential layout of the blade tip timing sensors is optimized and determined according to a condition number of the sensor measurement matrix, i.e.,

$$cond ( Θ ) = ‖Θ‖▯ ‖ {Θ}^{- 1} ‖ ;$$

in the first step S1 of the method, in the second step S2 of the method, the blade tip timing sensors are mounted on an engine casing according to the position optimization, wherein the smaller the mounting angle of the blade tip timing sensor, the better under the condition that the actual situation is satisfied, the blade tip timing test is performed, and the time of the blade arriving at the sensors is measured;
S2011, when a blade tip timing system is provided with an OPR rotational speed sensor, calculating a reference rotational speed fᵣ within the n^{th} revolution according to a time sequence τ_{OPR,n} measured by the OPR sensor, wherein

$${f}_{r} = \frac{1}{{τ}_{OPR , n + 1} - {τ}_{OPR , n}} ;$$

S2021, when the blade tip timing system is not provided with an OPR rotational speed sensor, calculating a reference rotational speed fᵣ within the n^{th} revolution without a rotational speed as a reference according to a time-of-arrival sequence t_{i,b,n} of the N_{b}^{th} blade measured by the Nₚ^{th} blade tip timing sensor, wherein

$${f}_{r} = \frac{1}{{N}_{b} {N}_{ρ}} {\sum }_{b = 1}^{{N}_{b}} {\sum }_{i}^{{N}_{ρ}} ( {t}_{i , b , n + 1} - {t}_{i , b , n} ) \{ \begin{matrix}i = 1 , 2 , … {N}_{p} \\ b = 1 , 2 , … {N}_{b} \\ n = 1 , 2 , … , N\end{matrix} ;$$

in the third step S3 of the method, the blade tip vibration displacement, the blade tip vibration velocity, the blade tip vibration acceleration, and the blade tip vibration jerk are calculated using the time of arrival and the mounting angles of the sensors, respectively, according to different identification requirements of low-frequency, medium-frequency, high-frequency and super-high-frequency vibration parameters;
S301, when a low-frequency vibration parameter needs to be identified based on blade tip timing, obtaining an ideal time of arrival \hat{t}_{i,b,n} of the blade according to the reference rotational speed as a reference and the mounting angles of the sensors; obtaining a time difference Δ_{i,b,n} in combination with measured actual time of the blade arriving at the sensor, wherein Δt_{i,b,n}=\hat{t}_{i,b,n}−t_{i,b,n}; obtaining a vibration displacement d_{i,b,n} of the b^{th} blade tip within the n^{th} revolution measured by the i^{th} blade tip timing sensor according to the measured rotation radius R_{BTT} from the rotor-tip rotation axis to the blade tip, wherein d_{i,b,n}=2πR_{BTT}Δt_{i,b,n};
S302, when a medium-frequency vibration parameter needs to be identified based on blade tip timing, calculating a vibration velocity ν_{b,n}^{i,j} of the b^{th} blade tip within the n^{th} revolution using two adjacent blade tip timing sensors, i.e., the i^{th} blade tip timing sensor and the j=i+1^{th} blade tip timing sensor, and the measured time-of-arrival sequence according to the relationship between the time of arrival of the blade measured by the blade tip timing sensor and the mounting angle between adjacent sensors, wherein

$${v}_{b , n}^{i , j} = {R}_{BTT} ( \frac{{θ}_{j} - {θ}_{i}}{{t}_{j , b , n} - {t}_{i , b , n}} - 2 π {f}_{r} ) ;$$

S303, when a high-frequency vibration parameter needs to be identified based on blade tip timing, calculating a vibration acceleration according to the mounting angles of three adjacent blade tip timing sensors and the measured actual time of arrival, specifically, calculating a vibration acceleration a_{b,n}^{i,j,l} of the b^{th} blade tip within the n^{th} revolution using the three adjacent blade tip timing sensors, i.e., the i^{th} blade tip timing sensor, the j=i+1^{th} blade tip timing sensor, and the l=i+2^{th} blade tip timing sensor, and the measured actual time-of-arrival sequence, wherein

$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ,$$

where β represents the angular acceleration of the rotor;
S3031, when the rotor speed is constant, the angular acceleration of the rotor is β=0, at this time, the blade tip vibration acceleration can be expressed as:

$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} ,$$

and at this time, an OPR sensor does not need to be additionally mounted;
S3032, when the rotor speed is variable, the angular acceleration of the rotor speed is β≠0, at this time, the blade tip vibration acceleration can be expressed as:

$${a}_{b , n}^{i , j , l} = 2 {R}_{BTT} \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β$$

S304, when a super-high-frequency vibration parameter needs to be identified based on blade tip timing, obtaining a blade tip vibration jerk according to the mounting angles of four adjacent blade tip timing sensors and the measured time of arrival of the blade, specifically, calculating the vibration jerk γ_{b,n}^{i,j,l,q} of the b^{th} blade tip within the n^{th} revolution using the four adjacent blade tip timing sensors, i.e., the i^{th} blade tip timing sensor, the j=i+1^{th} blade tip timing sensor, the l=i+2^{th} blade tip timing sensor, and the q=i+3^{th} blade tip timing sensor, and the measured time-of-arrival sequence, wherein

$${γ}_{b , n}^{i , j , l , q} = 2 {R}_{BTT} \frac{\frac{( \frac{{θ}_{q} - {θ}_{l}}{{t}_{q , b , n} - {t}_{l , b , n}} - \frac{{θ}_{l} - {θ}_{j}}{{t}_{l , b , n} - {t}_{jb , n}} )}{{t}_{q , b , n} - {t}_{j , b , n}} - \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}}}{\frac{{t}_{q , b , n} + 2 {t}_{l , b , n} + {t}_{j , b , n}}{4} - \frac{{t}_{l , b , n} + 2 {t}_{j , b , n} + {t}_{i , b , n}}{4}} ;$$

In the fourth step S4 of the method, a blade tip vibration measuring response Y is generated according to the blade tip vibration displacement, the blade tip vibration velocity, the blade tip vibration acceleration and the blade tip vibration jerk, and the blade tip timing vibration parameters

$$Φ == {( {\sum }_{i = 1}^{M} {Θ}^{T} Θ )}^{- 1} ( {\sum }_{i = 1}^{M} {Θ}^{T} Y )$$

at different frequency bands are solved by a least squares method;
S401, finally obtaining a blade vibration displacement parameter according to a conversion relationship between the measured blade tip vibration displacement, blade tip vibration velocity, blade tip vibration acceleration and blade tip vibration jerk;
S4011, obtaining amplitude Am_{f}_{_{L}} and phase Ψ_{f}_{_{L}} of low-frequency vibration of the blade by solving the vibration displacement;
S4012, obtaining amplitude Am_{f}_{_{M}} and phase Ψ_{f}_{_{M}} of medium-frequency vibration of the blade by solving the vibration velocity, wherein

$${Am}_{{f}_{M}} = 2 π {f}_{L} {Am}_{{f}_{L}} , {Ψ}_{{f}_{M}} = {Ψ}_{{f}_{L}} - \frac{π}{2} ;$$

S4013, obtaining amplitude Am_{f}_{_{H}} and phase Ψ_{f}_{_{H}} of high-frequency vibration of the blade by solving the vibration acceleration, wherein Am_{f}_{_{H}}=(2πf_{L})²Am_{f}_{_{L}}, Ψ_{f}_{_{H}}=Ψ_{f}_{_{L}}−π;
S4014, obtaining amplitude Am_{f}_{_{S}} and phase Ψ_{f}_{_{S}} of super-high-frequency vibration of the blade by solving the vibration jerk, wherein

$${Am}_{{f}_{s}} = {( 2 π {f}_{L} )}^{3} {Am}_{{f}_{L}} , {Ψ}_{{f}_{s}} = {Ψ}_{{f}_{L}} - \frac{3 π}{2} .$$

According to another aspect of the present disclosure, a system for implementing the method for blade tip timing measurement of full-frequency-domain vibration of a rotor blade includes:
a sensor layout optimization module, configured to determine the number and circumferential mounting positions of blade tip timing sensors for measuring the vibration of the rotor blade based on different parameters of the blade at low frequency, medium frequency, high frequency, and super-high frequency, wherein the smaller the angular interval between the sensors, the better in the condition that the actual situation is satisfied, and it is recommended that the interval between two adjacent sensors is within 10°;
a time-of-arrival online measurement module, configured to acquire a time sequence of the rotor blade arriving at the blade tip timing sensors;
a blade tip vibration calculation module, configured to calculate a blade tip vibration displacement identified at a low frequency, a blade tip vibration velocity identified at a medium frequency, a blade tip vibration acceleration identified at a high frequency, and a blade tip vibration jerk identified at a super-high frequency using the measured time sequence according to different frequency identification requirements and converting the blade tip vibration displacement, the blade tip vibration velocity, the blade tip vibration acceleration and the blade tip vibration jerk into a blade vibration parameter; and
a vibration parameter identification module, configured to obtain the frequency, amplitude, and phase of the rotor blade at the low frequency, the medium frequency, the high frequency, and the super-high frequency by a least squares algorithm based on the blade tip vibration displacement, the blade tip vibration velocity, the blade tip vibration acceleration, and the blade tip vibration jerk.

Finally, it should be noted that the described embodiments are only some but not all of the embodiments of the present application, and all other embodiments obtained by those skilled in the art without making inventive steps based on the embodiments of the present application are within the scope of the present application.

While certain exemplary embodiments of the present disclosure have been described above by way of illustration only, it will be appreciated that those skilled in the art will be able to modify the described embodiments in various ways without departing from the spirit and scope of the present disclosure. Accordingly, the foregoing drawings and description are illustrative and should not be construed as limiting the scope of the disclosure as claimed.

1. A method for blade tip timing measurement of full-frequency-domain vibration of a rotor blade, comprising the following steps:
first step S1, performing prestress modal analysis on the rotor blade to obtain a low-frequency mode parameter with a vibration frequency being less than 500 Hz, a medium-frequency mode parameter with a vibration frequency in the range of 500 Hz-2000 Hz, a high-frequency mode parameter with a vibration frequency in the range of 2000 Hz-5000 Hz and a super-high frequency mode parameter with a vibration frequency being greater than 5000 Hz, to determine the number and mounting angles of blade tip timing sensors;
second step S2, mounting the blade tip timing sensors on an engine casing circumferentially to obtain a time sequence of the rotor blade arriving at the blade tip timing sensors, and determining a reference rotational speed based on the time sequence;
third step S3, obtaining an ideal time of arrival \hat{t}_{i,b,n} of the blade according to the reference rotational speed and the mounting angles of the sensors based on the low-frequency vibration parameter with the vibration frequency being less than 500 Hz, obtaining a time difference Δt_{i,b,n} in combination with the measured actual time t_{i,b,n} of the rotor blade arriving at the blade tip timing sensors, wherein Δt_{i,b,n}=\hat{t}_{i,b,n}−t_{i,b,n}, obtaining a blade tip vibration displacement based on a measured rotation radius R_{BTT} from a rotor-tip rotation axis to a blade tip and the time difference Δt_{i,b,n}, obtaining a blade tip vibration velocity according to a relationship between the measured actual time of arrival of the blade and the mounting angles of adjacent sensors based on the medium-frequency vibration parameter with the vibration frequency in the range of 500 Hz-2000 Hz, obtaining a blade tip vibration acceleration according to the mounting angles of three adjacent blade tip timing sensors and the measured actual time of arrival of the blade based on the high-frequency vibration parameter with the vibration frequency in the range of 2000 Hz-5000 Hz, and obtaining a blade tip vibration jerk according to the mounting angles of four adjacent blade tip timing sensors and the measured actual time of arrival of the blade based on the super-high-frequency vibration parameter with the vibration frequency being greater than 5000 Hz, wherein the vibration parameters comprise a frequency, an amplitude and a phase; and
fourth step S4, obtaining a vibration frequency, amplitude, and phase of the rotor blade at the low frequency, the medium frequency, the high frequency, and the super-high frequency using the obtained blade tip vibration displacement, blade tip vibration velocity, blade tip vibration acceleration, and blade tip vibration jerk.

2. The method according to claim 1, wherein in the first step S1, prestress modal analysis is performed on the rotor blade to obtain a low-frequency mode f_{L} with a vibration frequency being less than 500 Hz, a medium-frequency mode f_{M} with a vibration frequency in the range of 500 Hz-2000 Hz, a high-frequency mode f_{H} with the vibration frequency in the range of 2000 Hz-5000 Hz and a super-high-frequency mode f_{S} with the vibration frequency being greater than 5000 Hz of the rotor blade at a given operating condition; the number Nₚ of the blade tip timing sensors is determined based on the number m of frequency components of the low-frequency mode f_{L}, the medium-frequency mode f_{M}, the high-frequency mode f_{H}, and the super-high-frequency mode f_{S}, wherein, Nₚ≥2m+1.

3. The method according to claim 2, wherein in the first step S1, a blade tip timing sensor circumferential mounting angle measurement matrix Θ is constructed according to the frequency components of the low-frequency mode f_{L}, the medium-frequency mode f_{M}, the high-frequency mode f_{H} and the super-high-frequency mode f_{S}, wherein an expression of the angle measurement matrix Θ is:
$$Θ = [ \begin{matrix}sin ( 2 π {f}_{L} {θ}_{1} ) & cos ( 2 π {f}_{L} {θ}_{1} ) & sin ( 2 π {f}_{M} {θ}_{1} ) & cos ( 2 π {f}_{M} {θ}_{1} ) & sin ( 2 π {f}_{H} {θ}_{1} ) & cos ( 2 π {f}_{H} {θ}_{1} ) & sin ( 2 π {f}_{S} {θ}_{1} ) & sin ( 2 π {f}_{S} {θ}_{1} ) \\ sin ( 2 π {f}_{L} {θ}_{2} ) & cos ( 2 π {f}_{L} {θ}_{2} ) & sin ( 2 π {f}_{M} {θ}_{2} ) & cos ( 2 π {f}_{M} {θ}_{2} ) & sin ( 2 π {f}_{H} {θ}_{2} ) & cos ( 2 π {f}_{H} {θ}_{2} ) & sin ( 2 π {f}_{S} {θ}_{2} ) & cos ( 2 π {f}_{S} {θ}_{2} ) \\ ⋮ & ⋮ & ⋮ & ⋮ & ⋮ & ⋮ & ⋮ & ⋮ \\ sin ( 2 π {f}_{L} {θ}_{{N}_{p}} ) & cos ( 2 π {f}_{L} {θ}_{{N}_{p}} ) & sin ( 2 π {f}_{M} {θ}_{{N}_{p}} ) & cos ( 2 π {f}_{M} {θ}_{{N}_{p}} ) & sin ( 2 π {f}_{H} {θ}_{{N}_{p}} ) & cos ( 2 π {f}_{H} {θ}_{{N}_{p}} ) & sin ( 2 π {f}_{S} {θ}_{{N}_{p}} ) & cos ( 2 π {f}_{S} {θ}_{{N}_{p}} )\end{matrix} ]$$
where θ_{N}_{ₚ} is the mounting angle between the Nₚ^{th} blade tip timing sensor and the rotational speed sensor; a circumferential layout cond(Θ)=∥Θ∥□∥Θ⁻¹∥ of the blade tip timing sensors is determined according to a condition number of the angle measurement matrix.

4. The method according to claim 1, wherein in the second step S2, an OPR rotational speed sensor is mounted to measure the time sequence τ_{OPR,n}, and a reference rotational speed fᵣ within the n^{th} revolution is calculated according to the time sequence τ_{OPR,n}, wherein
$${f}_{r} = \frac{1}{{τ}_{OPR , n + 1} - {τ}_{OPR , n}} .$$

5. The method according to claim 1, wherein in the second step S2, the reference rotational speed fᵣ within the n^{th} revolution is calculated according to the actual time of arrival t_{i,b,n} of the N_{b}^{th} blade measured by the Nₚ^{th} blade tip timing sensor:
$${f}_{r} = \frac{1}{{N}_{b} {N}_{p}} {\sum }_{b = 1}^{{N}_{b}} {\sum }_{i}^{{N}_{p}} ( {t}_{i , b , n + 1} - {t}_{i , b , n} ) \{ \begin{matrix}i = 1 , 2 , … {N}_{p} \\ b = 1 , 2 , … {N}_{b} \\ n = 1 , 2 , … , N\end{matrix} .$$

6. The method according to claim 5, wherein the third step S3 comprises:
S301, obtaining a vibration displacement d_{i,b,n} of the b^{th} blade tip within the n^{th} revolution measured by the i^{th} blade tip timing sensor according to the measured rotation radius R_{BTT} from the rotor-tip rotation axis to the blade tip based on the low-frequency vibration parameter with the vibration frequency being less than 500 Hz, wherein, d_{i,b,n}=2πR_{BTT}Δt_{i,b,n}, wherein the time difference Δt_{i,b,n}=\hat{t}_{i,b,n}−Δt_{i,b,n};
S302, calculating a vibration velocity ν_{b,n}^{i,j} of the b^{th} blade tip within the n^{th} revolution using two adjacent blade tip timing sensors, i.e., the i^{th} blade tip timing sensor and the j=i+1^{th} blade tip timing sensor, and the measured actual time of arrival based on the medium-frequency vibration parameter with the vibration frequency in the range of 500 Hz-2000 Hz, wherein
$${v}_{b , n}^{i , j} = {R}_{BTT} ( \frac{{θ}_{j} - {θ}_{i}}{{t}_{j , b , n} - {t}_{i , b , n}} - 2 π {f}_{r} ) ,$$
θᵢ and θᵢ are the mounting angles between the i^{th} blade tip timing sensor and the j^{th} blade tip timing sensor and the rotational speed sensor, respectively, the actual time of the blade arriving at the i^{th} blade tip timing sensor is t_{i,b,n}, and the actual time of the blade arriving at the j^{th} blade tip timing sensor is t_{j,b,n};
S303, calculating a vibration acceleration a_{b,n}^{i,j,l} of the b^{th} blade tip within the n^{th} revolution using three adjacent blade tip timing sensors, i.e., the i^{th} blade tip timing sensor, the j=i+1^{th} blade tip timing sensor, and the l=i+2^{th} blade tip timing sensor, and the measured actual time of arrival based on the high-frequency vibration parameter with the vibration frequency in the range of 2000 Hz-5000 Hz, wherein
$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ,$$
where β represents the angular acceleration of the rotor; when the rotor speed is constant, the angular acceleration of the rotor is β=0, at this time, the blade tip vibration acceleration is expressed as:
$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} ;$$
when the rotor speed is variable, the angular acceleration of the rotor is β≠0, at this time, the blade tip vibration acceleration is expressed as:
$${a}_{b , n}^{i , j , l} = 2 {R}_{BTT} \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ;$$
S304, calculating a vibration jerk γ_{b,n}^{i,j,l,q} of the b^{th} blade tip within the n^{th} revolution using four adjacent blade tip timing sensors, i.e., the i^{th} blade tip timing sensor, the j=i+l^{th} blade tip timing sensor, the l=i+2^{th} blade tip timing sensor, and the q=i+3^{th} blade tip timing sensor, and the measured actual time-of-arrival sequence based on the super-high-frequency vibration parameter with the vibration frequency being greater than 5000 Hz, wherein,
$${γ}_{b , n}^{i , j , l , q} = 2 {R}_{BTT} \frac{\frac{( \frac{{θ}_{q} - {θ}_{l}}{{t}_{q , b , n} - {t}_{l , b , n}} - \frac{{θ}_{l} - {θ}_{j}}{{t}_{l , b , n} - {t}_{jb , n}} )}{{t}_{q , b , n} - {t}_{j , b , n}} - \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}}}{\frac{{t}_{q , b , n} + 2 {t}_{l , b , n} + {t}_{j , b , n}}{4} - \frac{{t}_{l , b , n} + 2 {t}_{j , b , n} + {t}_{i , b , n}}{4}} .$$

7. The method according to claim 1, wherein in the fourth step S4, a blade tip vibration measurement response Y is generated according to the blade tip vibration displacement, the blade tip vibration velocity, the blade tip vibration acceleration and the blade tip vibration jerk, and blade tip timing vibration parameters
$$Φ == {( {\sum }_{i = 1}^{M} {Θ}^{T} Θ )}^{- 1} ( {\sum }_{i = 1}^{M} {Θ}^{T} Y )$$
at different frequency bands are solved by a least squares method.

8. The method according to claim 7, wherein the blade tip timing vibration parameter is solved based on the vibration displacement to obtain low-frequency vibration amplitude Am_{f}_{_{L}} and phase Ψ_{f}_{_{L}} of the blade, the blade tip timing vibration parameter is solved based on the vibration velocity to obtain medium-frequency vibration amplitude Am_{f}_{_{M}} and phase Ψ_{f}_{_{M}} of the blade, wherein
$${Am}_{{f}_{M}} = 2 π {f}_{L} {Am}_{{f}_{L}} ,$$
$${Ψ}_{{f}_{M}} = {Ψ}_{{f}_{L}} - \frac{π}{2} ;$$
the blade tip timing vibration parameter is solved based on the vibration acceleration to obtain high-frequency vibration amplitude Am_{f}_{_{H}} and phase Ψ_{f}_{_{H}} of the blade, wherein Am_{f}_{_{H}}=(2πf_{L})²Am_{f}_{_{L}}, Ψ_{f}_{_{H}}=Ψ_{f}_{_{L}}−π; the blade tip timing vibration parameter is solved based on the vibration jerk to obtain super-high-frequency vibration amplitude Am_{f}_{_{S}} and phase Ψ_{f}_{_{S}} of the blade, wherein
$${Am}_{{f}_{s}} = {( 2 π {f}_{L} )}^{3} {Am}_{{f}_{L}} ,$$
$${Ψ}_{{f}_{s}} , = {Ψ}_{{f}_{L}} - \frac{3 π}{2} .$$

9. A system for implementing the method for blade tip timing measurement of full-frequency-domain vibration of a rotor blade according to claim 1, comprising:
a sensor layout optimization module, configured to determine the number and circumferential mounting positions of blade tip timing sensors for measuring vibration of the rotor blade based on low-frequency, medium-frequency, high-frequency, and super-high-frequency vibration parameters of the rotor blade;
a time-of-arrival online measurement module, configured to acquire a time sequence of the rotor blade arriving at the blade tip timing sensors;
a blade tip vibration calculation module, connected with the time-of-arrival online measurement module and the sensor layout optimization module, and configured to calculate a blade tip vibration displacement identified at a low frequency, a blade tip vibration velocity identified at a medium frequency, a blade tip vibration acceleration identified at a high frequency, and a blade tip vibration jerk identified at a super-high frequency using the measured time sequence; and
a vibration parameter identification module, connected with the blade tip vibration calculation module and the time-of-arrival online measurement module, and configured to obtain the frequency, amplitude, and phase of the rotor blade at the low frequency, the medium frequency, the high frequency, and the super-high frequency by a least squares algorithm based on the blade tip vibration displacement, the blade tip vibration velocity, the blade tip vibration acceleration, and the blade tip vibration jerk.

10. The system according to claim 9, wherein an interval between two adjacent blade tip timing sensors is within 10°.

11. The system for implementing the method of claim 9, wherein in the first step S1, prestress modal analysis is performed on the rotor blade to obtain a low-frequency mode f_{L} with a vibration frequency being less than 500 Hz, a medium-frequency mode f_{M} with a vibration frequency in the range of 500 Hz-2000 Hz, a high-frequency mode f_{H} with the vibration frequency in the range of 2000 Hz-5000 Hz and a super-high-frequency mode f_{S} with the vibration frequency being greater than 5000 Hz of the rotor blade at a given operating condition; the number Nₚ of the blade tip timing sensors is determined based on the number m of frequency components of the low-frequency mode f_{L}, the medium-frequency mode f_{M}, the high-frequency mode f_{H}, and the super-high-frequency mode f_{S}, wherein, Nₚ≥2m+1.

12. The system for implementing the method of claim 11, wherein in the first step S1, a blade tip timing sensor circumferential mounting angle measurement matrix Θ is constructed according to the frequency components of the low-frequency mode f_{L}, the medium-frequency mode f_{M}, the high-frequency mode f_{H} and the super-high-frequency mode f_{S}, wherein an expression of the angle measurement matrix Θ is:
$$Θ = [ \begin{matrix}sin ( 2 π {f}_{L} {θ}_{1} ) & cos ( 2 π {f}_{L} {θ}_{1} ) & sin ( 2 π {f}_{M} {θ}_{1} ) & cos ( 2 π {f}_{M} {θ}_{1} ) & sin ( 2 π {f}_{H} {θ}_{1} ) & cos ( 2 π {f}_{H} {θ}_{1} ) & sin ( 2 π {f}_{S} {θ}_{1} ) & sin ( 2 π {f}_{S} {θ}_{1} ) \\ sin ( 2 π {f}_{L} {θ}_{2} ) & cos ( 2 π {f}_{L} {θ}_{2} ) & sin ( 2 π {f}_{M} {θ}_{2} ) & cos ( 2 π {f}_{M} {θ}_{2} ) & sin ( 2 π {f}_{H} {θ}_{2} ) & cos ( 2 π {f}_{H} {θ}_{2} ) & sin ( 2 π {f}_{S} {θ}_{2} ) & cos ( 2 π {f}_{S} {θ}_{2} ) \\ ⋮ & ⋮ & ⋮ & ⋮ & ⋮ & ⋮ & ⋮ & ⋮ \\ sin ( 2 π {f}_{L} {θ}_{{N}_{p}} ) & cos ( 2 π {f}_{L} {θ}_{{N}_{p}} ) & sin ( 2 π {f}_{M} {θ}_{{N}_{p}} ) & cos ( 2 π {f}_{M} {θ}_{{N}_{p}} ) & sin ( 2 π {f}_{H} {θ}_{{N}_{p}} ) & cos ( 2 π {f}_{H} {θ}_{{N}_{p}} ) & sin ( 2 π {f}_{S} {θ}_{{N}_{p}} ) & cos ( 2 π {f}_{S} {θ}_{{N}_{p}} )\end{matrix} ]$$
where θ_{N}_{ₚ} is the mounting angle between the Nₚ^{th} blade tip timing sensor and a rotational speed sensor; a circumferential layout cond(Θ)=∥Θ∥□∥Θ⁻¹∥ of the blade tip timing sensors is determined according to a condition number of the angle measurement matrix.

13. The system for implementing the method of claim 9, wherein in the second step S2, an OPR rotational speed sensor is mounted to measure the time sequence τ_{OPR,n}, and a reference rotational speed fᵣ within the n^{th} revolution is calculated according to the time sequence τ_{OPR,n}, wherein
$${f}_{r} = \frac{1}{{τ}_{OPR , n + 1} - {τ}_{OPR , n}} .$$

14. The system for implementing the method of claim 9, wherein in the second step S2, the reference rotational speed fᵣ within the n^{th} revolution is calculated according to the actual time of arrival t_{i,b,n} of the N_{b}^{th} blade measured by the Nₚ^{th} blade tip timing sensor:
$${f}_{r} = \frac{1}{{N}_{b} {N}_{p}} {\sum }_{b = 1}^{{N}_{b}} {\sum }_{i}^{{N}_{p}} ( {t}_{i , b , n + 1} - {t}_{i , b , n} ) \{ \begin{matrix}i = 1 , 2 , … {N}_{p} \\ b = 1 , 2 , … {N}_{b} \\ n = 1 , 2 , … , N\end{matrix} .$$

15. The system for implementing the method of claim 14, wherein the third step S3 comprises:
S301, obtaining a vibration displacement d_{i,b,n} of the b^{th} blade tip within the n^{th} revolution measured by the i^{th} blade tip timing sensor according to the measured rotation radius R_{BTT} from the rotor-tip rotation axis to the blade tip based on the low-frequency vibration parameter with the vibration frequency being less than 500 Hz, wherein, d_{i,b,n}=2πR_{BTT}Δt_{i,b,n}, wherein the time difference Δt_{i,b,n}=\hat{t}_{i,b,n}−Δt_{i,b,n};
S302, calculating a vibration velocity ν_{b,n}^{i,j} of the b^{th} blade tip within the n^{th} revolution using two adjacent blade tip timing sensors, i.e., the i^{th} blade tip timing sensor and the j=i+1^{th} blade tip timing sensor, and the measured actual time of arrival based on the medium-frequency vibration parameter with the vibration frequency in the range of 500 Hz-2000 Hz, wherein
$${v}_{b , n}^{i , j} = {R}_{BTT} ( \frac{{θ}_{j} - {θ}_{i}}{{t}_{j , b , n} - {t}_{i , b , n}} - 2 π {f}_{r} ) ,$$
θⱼ and θᵢ are the mounting angles between the i^{th} blade tip timing sensor and the j^{th} blade tip timing sensor and the rotational speed sensor, respectively, the actual time of the blade arriving at the i^{th} blade tip timing sensor is t_{i,b,n}, and the actual time of the blade arriving at the j^{th} blade tip timing sensor is t_{j,b,n};
S303, calculating a vibration acceleration a_{b,n}^{i,j,l} of the b^{th} blade tip within the n^{th} revolution using three adjacent blade tip timing sensors, i.e., the i^{th} blade tip timing sensor, the j=i+1^{th} blade tip timing sensor, and the l=i+2^{th} blade tip timing sensor, and the measured actual time of arrival based on the high-frequency vibration parameter with the vibration frequency in the range of 2000 Hz-5000 Hz, wherein
$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ,$$
where β represents the angular acceleration of the rotor; when the rotor speed is constant, the angular acceleration of the rotor is β=0, at this time, the blade tip vibration acceleration is expressed as:
$${a}_{b , n}^{i , j , l} = \frac{2 {R}_{BTT} ( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} ;$$
when the rotor speed is variable, the angular acceleration of the rotor is β≠0, at this time, the blade tip vibration acceleration is expressed as:
$${a}_{b , n}^{i , j , l} = 2 {R}_{BTT} \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}} - {R}_{BTT} β ;$$
S304, calculating a vibration jerk γ_{b,n}^{i,j,l,q} of the b^{th} blade tip within the n^{th} revolution using four adjacent blade tip timing sensors, i.e., the i^{th} blade tip timing sensor, the j=i+l^{th} blade tip timing sensor, the l=i+2^{th} blade tip timing sensor, and the q=i+3^{th} blade tip timing sensor, and the measured actual time-of-arrival sequence based on the super-high-frequency vibration parameter with the vibration frequency being greater than 5000 Hz, wherein,
$${γ}_{b , n}^{i , j , l , q} = 2 {R}_{BTT} \frac{\frac{( \frac{{θ}_{q} - {θ}_{l}}{{t}_{q , b , n} - {t}_{l , b , n}} - \frac{{θ}_{l} - {θ}_{j}}{{t}_{l , b , n} - {t}_{jb , n}} )}{{t}_{q , b , n} - {t}_{j , b , n}} - \frac{( \frac{{θ}_{l} - {θ}_{j}}{{t}_{l , b , n} - {t}_{j , b , n}} - \frac{{θ}_{j} - {θ}_{i}}{{t}_{j , b , n} - {t}_{i , b , n}} )}{{t}_{l , b , n} - {t}_{i , b , n}}}{\frac{{t}_{q , b , n} + 2 {t}_{l , b , n} + {t}_{j , b , n}}{4} - \frac{{t}_{l , b , n} + 2 {t}_{j , b , n} + {t}_{i , b , n}}{4}} .$$

16. The system for implementing the method of claim 9, wherein in the fourth step S4, a blade tip vibration measurement response Y is generated according to the blade tip vibration displacement, the blade tip vibration velocity, the blade tip vibration acceleration and the blade tip vibration jerk, and blade tip timing vibration parameters
$$Φ == {( {\sum }_{i = 1}^{M} {Θ}^{T} Θ )}^{- 1} ( {\sum }_{i = 1}^{M} {Θ}^{T} Y )$$
at different frequency bands are solved by a least squares method.

17. The system for implementing the method of claim 16, wherein the blade tip timing vibration parameter is solved based on the vibration displacement to obtain low-frequency vibration amplitude Am_{f}_{_{L}} and phase Ψ_{f}_{_{L}} of the blade, the blade tip timing vibration parameter is solved based on the vibration velocity to obtain medium-frequency vibration amplitude Am_{f}_{_{M}} and phase Ψ_{f}_{_{M}} of the blade, wherein
$${Am}_{{f}_{M}} = 2 π {f}_{L} {Am}_{{f}_{L}} ,$$
$${Ψ}_{{f}_{M}} = {Ψ}_{{f}_{L}} - \frac{π}{2} ;$$
the blade tip timing vibration parameter is solved based on the vibration acceleration to obtain high-frequency vibration amplitude Am_{f}_{_{H}} and phase Ψ_{f}_{_{H}} of the blade, wherein Am_{f}_{_{H}}=(2πf_{L})Am_{f}_{_{L}}, Ψ_{f}_{_{H}}=Ψ_{f}_{_{L}}−π; the blade tip timing vibration parameter is solved based on the vibration jerk to obtain super-high-frequency vibration amplitude Am_{f}_{_{S}} and phase Ψ_{f}_{_{S}} of the blade, wherein
$${Am}_{{f}_{s}} = {( 2 π {f}_{L} )}^{3} {Am}_{{f}_{L}} ,$$
$${Ψ}_{{f}_{s}} = {Ψ}_{{f}_{L}} - \frac{3 π}{2} .$$
